(19) United States
(12) Patent Application Publication
(10) Pub. No.: US 2007/0154746 A1
(43) Pub. Date: Jul. 5, 2007

(54) Purging a fuel cell system

(76) Inventors: Michael Penev, Albany, NY (US); Richard H. Cutright, Corinth, NY (US)

Correspondence Address: TROP PRUNER & HU, PC, 1616 S. VOSS ROAD, SUITE 750, HOUSTON, TX, 77057-2631, US

(21) Appl. No.: 11/478,198

(22) Filed: Jun. 29, 2006

Related U.S. Application Data
(60) Provisional application No. 60/754,927, filed on Dec. 29, 2005.

(51) Int. Cl. H01M 8/04

(52) U.S. Cl. 429/13; 429/17; 429/22

(57) ABSTRACT

A technique that is usable with a fuel cell system includes shutting off a fuel flow to an anode chamber of a fuel cell stack of the system. The technique includes providing an oxidant flow to fuel passageways of the fuel cell system until fuel is significantly purged from the system.

This application claims the benefit under 35 U.S.C. § 119(e) to U.S. Provisional Application Ser. No. 60/754,927, entitled “PURGING A FUEL CELL SYSTEM,” filed on Dec. 29, 2005, which is hereby incorporated by reference in its entirety.

### GOVERNMENT LICENSE RIGHTS

The U.S. Government has a paid-up license in this invention and the right in limited circumstances to require the patent owner to license others on reasonable terms as provided for by the terms of Contract No 70NANB1H3065, awarded by the National Institute of Standards and Technology.

### BACKGROUND

The invention generally relates to purging a fuel cell system.

A fuel cell is an electrochemical device that converts chemical energy directly into electrical energy. For example, one type of fuel cell includes a proton exchange membrane (PEM) that permits only protons to pass between an anode and a cathode of the fuel cell. Typically PEM fuel cells employ sulfonic-acid-based ionomers, such as Nafion, and operate in the 60° Celsius (C.) to 70° temperature range. Another type employs a phosphoric-acid-based polybenziamidazole, PBI, membrane that operates in the 150° to 200° temperature range. At the anode, diatomic hydrogen (a fuel) is reacted to produce hydrogen protons that pass through the PEM. The electrons produced by this reaction travel through circuitry that is external to the fuel cell to form an electrical current. At the cathode, oxygen is reduced and reacts with the hydrogen protons to form water. The anodic and cathodic reactions are described by the following equations:
H₂→2H⁺+2e⁻ at the anode of the cell, and Equation 1
O₂+4H⁺+4e⁻→2H₂O at the cathode of the cell. Equation 2

A typical fuel cell has a terminal voltage near one volt DC. For purposes of producing much larger voltages, several fuel cells may be assembled together to form an arrangement called a fuel cell stack, an arrangement in which the fuel cells are electrically coupled together in series to form a larger DC voltage (a voltage near 100 volts DC, for example) and to provide more power.

The fuel cell stack may include flow plates (graphite composite or metal plates, as examples) that are stacked one on top of the other, and each plate may be associated with more than one fuel cell of the stack. The plates may include various surface flow channels and orifices to, as examples, route the reactants and products through the fuel cell stack. Several PEMs (each one being associated with a particular fuel cell) may be dispersed throughout the stack between the anodes and cathodes of the different fuel cells. Electrically conductive gas diffusion layers (GDLs) may be located on each side of each PEM to form the anode and cathodes of each fuel cell. In this manner, reactant gases from each side of the PEM may leave the flow channels and diffuse through the GDLs to reach the PEM.

The fuel cell stack is one out of many components of a typical fuel cell system, as the fuel cell system includes various other components and subsystems, such as a cooling subsystem, a cell voltage monitoring subsystem, a control subsystem, a power conditioning subsystem, etc. The particular design of each of these subsystems is a function of the application that the fuel cell system serves.

Fuel cell systems contain combustible gases (i.e., flammable gases), which need to be removed, or purged, from the system when the system is shut down. If these gases are not purged, the system may possibly accumulate a combustible mixture of air and fuel as the air diffuses into the system through the exhaust or any other source. Conventionally, methane gas may be used to purge the fuel cell, as methane is more desirable than hydrogen in a system because methane has a narrow window of combustibility and also requires a high temperature of ignition. However, using methane to purge the fuel cell system may be potentially challenging due to methane emissions; and furthermore, the methane purge scheme does not allow for the usage of liquid fuels (as they change to liquid state when cooled).

Thus, there exists a continuing need for better ways to purge a fuel cell system when the system is to be shut down.

### SUMMARY

In an embodiment of the invention, a technique that is usable with a fuel cell system includes shutting off a fuel flow to an anode chamber of a fuel cell stack of the system. The technique includes providing an oxidant flow to fuel passageways of the fuel cell system until fuel is significantly purged from the system.

In another embodiment of the invention, a fuel cell system includes a fuel cell stack and a control subsystem. The fuel cell stack includes an anode chamber and a cathode chamber. The control subsystem is adapted to shut off a fuel flow to the anode chamber and provide an oxidant flow to fuel passageways of the fuel cell system until fuel is significantly purged from the system.

In yet another embodiment of the invention, a fuel cell system includes a fuel cell stack, an oxidant source, a fuel processor, a valve and a controller. The fuel cell stack includes an anode chamber and a cathode chamber. The oxidant source provides an oxidant source to the cathode chamber when the oxidant source is enabled. The fuel processor provides a reformate flow to the anode chamber. The valve controls a hydrocarbon flow to an inlet of the fuel processor. The controller shuts down the fuel cell system and is adapted to control the valve to shut off a fuel flow to the anode chamber and after the shutting off of the valve, continue to use algorithms, which are used during operation of the fuel cell stack before the shutting off of the valve to regulate operation of the fuel cell stack. The controller is also adapted to after shutting off the valve, shut down the fuel cell system in response to fuel being significantly purged from the system. The fuel cell system may also include a flow path to communicate an exhaust flow from the cathode chamber of the fuel cell stack to the inlet of the fuel processor.

Advantages and other features of the invention will become apparent from the following drawing, description and claims.

### BRIEF DESCRIPTION OF THE DRAWING

FIGS. 1 and 4 are schematic diagrams of fuel cell systems according to different embodiments of the invention.

FIGS. 2 and 3 are flow diagrams depicting techniques to shut down a fuel cell system according to embodiments of the invention.

### DETAILED DESCRIPTION

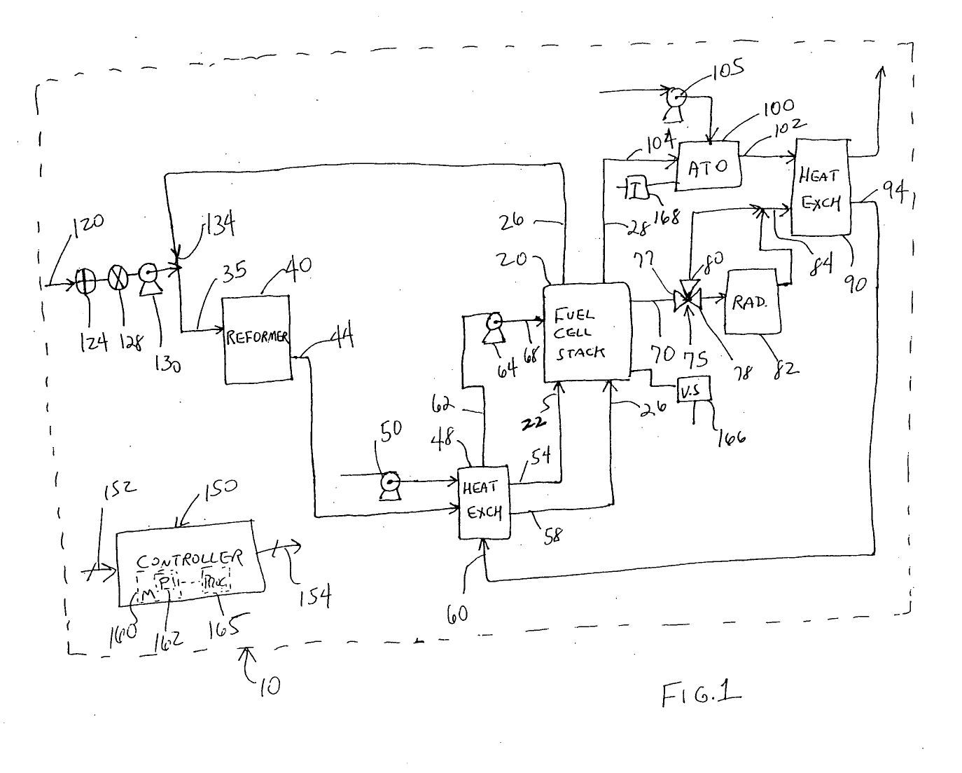

Referring to FIG. 1, a fuel cell system 10 in accordance with an embodiment of the invention includes a fuel cell stack 20 that produces electrical power for a load (not shown) in response to fuel and oxidant flows. In accordance with some embodiments of the invention, the fuel cell stack 20 may be formed from proton exchange membrane (PEM) fuel cells, although other types of fuel cells are possible in other embodiments of the invention. As described in more detail below, a controller 150 of the fuel cell system 10, during its normal operation, uses a set of algorithms to control the reactant flows to the fuel cell stack 20 based on measured current, voltages, temperatures, etc. During the shut down of the fuel cell system 10, the controller 150 cuts off, or halts, the flow of fuel to the fuel cell stack 20 while continuing to allow oxidant to flow to the stack 20. During this time the controller 150 controls the fuel cell stack 20 using the same set of control algorithms, which are used during normal stack operation. As further described below, due to the recirculation of the cathode exhaust to the fuel passageways of the fuel cell system 10, the continued oxidant flow purges any remaining fuel from the fuel cell stack 20 as well as from other components of the system 10. When the controller 150 determines (as described below) that the fuel has been significantly purged from the system 10, the controller 150 proceeds to then shut down the components of the system 10.

As a more specific example, in accordance with some embodiments of the invention, the fuel cell stack 20 receives an incoming oxidant flow at a cathode inlet 22. The incoming oxidant flow then flows into the cathode chamber of the fuel cell stack 20, which includes the cathode inlet plenum, the cathode flow channels and the cathode outlet of the fuel cell stack 20. The exhaust from the cathode chamber of the fuel cell stack 20 flows through a cathode exhaust outlet 26 of the stack 20. Fuel for the fuel cell stack 20 is received at an anode inlet 26. Thus, incoming fuel flows into the inlet 26 and into the anode chamber of the fuel cell stack 20. The “anode chamber” includes the anode inlet plenum, the anode flow channels and the output plenum receiving the anode exhaust. The anode exhaust exits the fuel cell stack 20 at an anode exhaust outlet 28.

In accordance with some embodiments of the invention, which recirculates the cathode exhaust back through the fuel cell stack 20. In this regard, in accordance with some embodiments of the invention, the fuel cell system 10 includes a fuel processor, or reformer 40, which provides a reformate flow (i.e., a fuel flow) for the fuel cell stack 20; and the cathode exhaust is introduced (at a mixing point 134) to an inlet 35 of the reformer 40. At the mixing point 134, the cathode exhaust is mixed with an incoming hydrocarbon flow (if any); and thus, a combined cathode exhaust and incoming hydrocarbon flow is communicated to the inlet 35 of the reformer 40. When the controller 150 shuts off the flow of fuel to the fuel cell stack 20, the controller 150 blocks the incoming hydrocarbon flow to the mixing point 134; and therefore, after turning off the fuel flow, the inlet 35 of the reformer 40 receives only the cathode exhaust flow from the cathode chamber of the fuel cell stack 20.

As depicted in FIG. 1, the incoming hydrocarbon flow to the mixing point 134 may be provided by a pump 130 whose inlet is connected to a valve 128 (a solenoid valve, for example). The valve 128, in turn, is controlled by the controller 150 to selectively close and open the hydrocarbon flow to the reformer 40. Thus, when the fuel cell system 10 is to be shut down, the controller 150 closes the valve 128, as described above. During normal operation, however, the controller 150 leaves the valve 128 open to establish an incoming hydrocarbon flow to the reformer 40. As also depicted in FIG. 1, in accordance with some embodiments of the invention, the fuel cell system 10 may include a pressure regulator 124 to regulate the pressure of the incoming hydrocarbon flow that is received at an inlet 120.

In accordance with some embodiments of the invention, the anode exhaust outlet 28 is coupled to an inlet 104 of an oxidizer 100. In addition to the anode exhaust flow, the oxidizer 100 may receive an incoming oxidant flow from a blower 105, for example. The oxidizer 100 reduces emissions in an exhaust from the oxidizer 100, which appears at an outlet 102. In accordance with some embodiments of the invention, the purging of fuel from the fuel cell system 10 means the elimination of any significant concentration of fuel in not only the fuel cell stack 20, but also other components of the fuel cell system 10, such as the oxidizer 100, for example.

Pursuant to the scheme used to purge the fuel cell system 10, the valve 128 is first closed by the controller 150, an action that results in a transition in the reformer 40 from being fuel rich to fuel lean and then only to processing air. The transition is abrupt, which produces a relatively low amount stoichiometric fuel mix and a relatively amount of energy that is associated with the transition. The temperature of catalysts and canisters is not significantly affected, as the energy that is released from the transition is low for the heat capacity of the catalyst and canisters. Once the transition occurs, the downstream components experience a transition from a reducing environment, then to a neutral environment and finally to an oxidizing (air) environment. The flammable gases in the fuel cell system 10 are thus displaced to the oxidizer 100; and once they have been totally displaced from the oxidizer 100, the controller 150 shuts off the oxidizer 100, as further described below.

The purge scheme that is disclosed herein takes only as long as it required to displace a volume of reformer in a fuel cell gas under the flow rate of the cathode. Overall, the shut down time may be as short as a few seconds (in accordance with some embodiments of the invention); and at this point, the fuel cell system is safe to walk away from.

Among the other features of the fuel cell system 10, the system 10 may include a coolant subsystem that is formed from heat exchangers 48 and 90 and a coolant pump 64. In this regard, the coolant pump 64 may furnish coolant to a coolant input 68 of the fuel cell stack 20. The coolant flows through coolant flow channels of the fuel cell stack 20 for purposes of removing thermal energy from the fuel cell stack 20. The coolant, now carrying thermal energy from the fuel cell stack 20, is removed from the fuel cell stack 20 at a coolant outlet 70. Depending on the particular position of a three-way valve 75, the coolant may pass through a radiator 82 to a inlet 84 of the heat exchanger 90 or may, alternatively, pass directly to the inlet 84. Thus, during the startup of the fuel cell system 10, the radiator 82 may be bypassed. However, during the normal operation of the fuel cell system 10, the radiator 82 removes heat from the coolant.

The coolant flow exits the radiator 82 and flows through the heat exchanger 90 for purposes of reducing the temperature of an exhaust from the oxidizer 100. An outlet 94 of the heat exchanger 90 is connected to an inlet 60 of the heat exchanger 48. The heat exchanger 48 lowers the temperature of the incoming oxidant flow (provided by a blower 50); and a coolant output 62 of the heat exchanger 48 furnishes the coolant back to the coolant pump 64.

The fuel cell system 10 also includes the controller 150, which has input terminals 152 for purposes of receiving various indications of sensed signals (voltages and currents), other status signals, indications of commands, etc., from the fuel cell system 10. The input signals to the controller 150 may also indicate when the purging of the fuel from the system 10 is complete during the shut down of the system, as further described below. The controller 150 processes the signals and provides corresponding signals at output terminals 154. The output signals may include, for example, signals to control various valves and motors of the fuel cell system 10, signals to communicate commands to other components of the fuel cell system 10, signals to indicate status of components of the fuel cell system 10, etc. As depicted in FIG. 1, in accordance with some embodiments of the invention, the controller 150 may include a memory 160 that stores various program instructions 162, which when executed by a processor 165 of the controller 150, causes the controller 150 to perform the techniques that are described herein. It is noted that the processors 165 may be formed from one or more microprocessors and/or microcontrollers, depending on the particular embodiment of the invention.

For purposes of determining when fuel has been purged from the fuel cell system 10, in accordance with some embodiments of the invention, the controller 150 monitors (via a signal that is provided by a voltage sensor 166, for example) a voltage of the fuel cell stack 20. Thus, when the controller 150 determines that the stack voltage has decreased below a threshold voltage (a voltage near 10 percent of the normal operating voltage of the fuel cell stack 20, for example), the controller 150 then deems that the fuel has been purged from the fuel cell stack 20. In accordance with some embodiments of the invention, the controller 150 may also monitor a temperature of the oxidizer 100 for purposes of determining when the fuel has been purged from the oxidizer 100. In this regard, in accordance with some embodiments of the invention, the controller 150 may monitor a temperature (via a temperature sensor 168, for example) of the oxidizer 100. In response to determining that the temperature of the oxidizer 100 has decreased below a predetermined temperature threshold, the controller 150 then deems that the fuel has been purged from the oxidizer 100. Other techniques may be used for purposes of determining when fuel has been significantly purged from the fuel cell system 10, in accordance with other embodiments of the invention. Thus, many variations are possible and are within the scope of the appended claims.

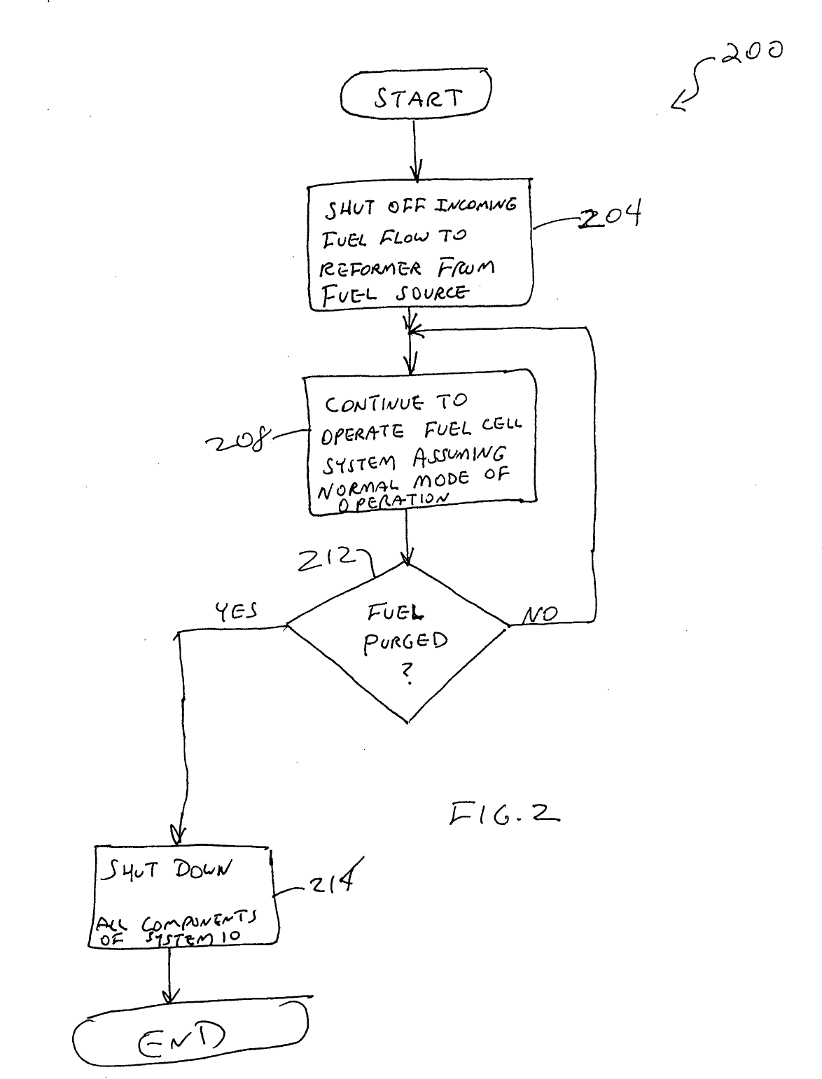

Referring to FIG. 2 in conjunction with FIG. 1, to summarize, in accordance with some embodiments of the invention, the controller 150 performs a technique 200 for purposes of shutting down the fuel cell system 10. Pursuant to the technique 200, the controller 150 shuts off (block 204) the incoming fuel flow to the reformer 40 from its fuel source and then continues (block 208) to operate the fuel cell system 10 assuming a normal mode of operation, as depicted in block 208. In other words, the controller 150 continues to operate the fuel cell system 10 using the same control algorithms that are used when the fuel cell system 10 is operating in its normal mode of operation and not being shut down.

Pursuant to the technique 200, the controller 150 continually determines (diamond 212) whether the fuel has been purged from the fuel cell system 10; and if not, the operation of the fuel cell system 10 continues, pursuant to block 208. Otherwise, the purging is complete, and the controller 150 shuts down (pursuant to block 214) all of the components of the system 10.

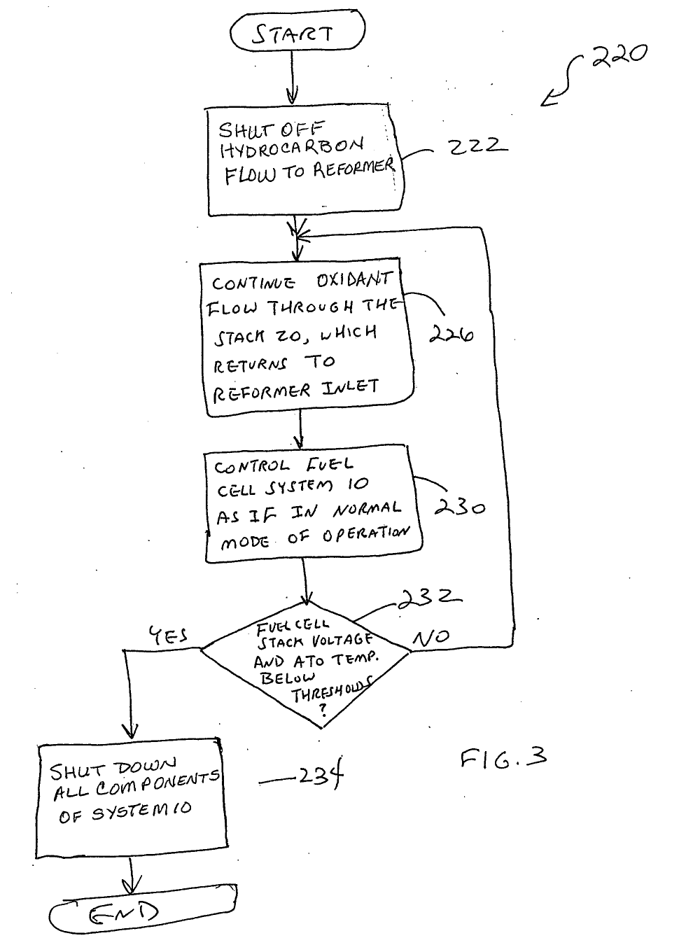

As a more specific example, the controller 150 may perform a technique 220 that is depicted in FIG. 3. Pursuant to the technique 220, the controller 150 shuts off (block 222) the hydrocarbon flow to the reformer 40 and continues (block 226) the oxidant flow through the stack 20, which returns to the reformer inlet. The controller 150 (block 230) the fuel cell system 10 as if in a normal mode of operation. The controller 150 continually determines (diamond 232) whether the fuel cell stack voltage and the temperature of the oxidizer 100 are below their thresholds. If not, control returns to block 226. Otherwise, the controller 150 shuts down all components of the system 10, pursuant to block 234.

Other variations are possible and are within the scope of the appended claims. For example, in accordance with other embodiments of the invention, the fuel cell system may not include a cathode recirculation path. For example, the above-described purge technique may be applied to fuel cell systems that do not include a cathode recirculation path because the fuel cell system may contain pyrophoric catalysts, or other materials, which cannot be exposed to air while hot. For these systems, the oxidant may be supplied directly from the blower 50 without first passing through the fuel cell stack 20. As another example, if the reformer does not include a low temperature shift (LTS) reactor that overheats without an air flow, the cathode recirculation path may likewise not be used.

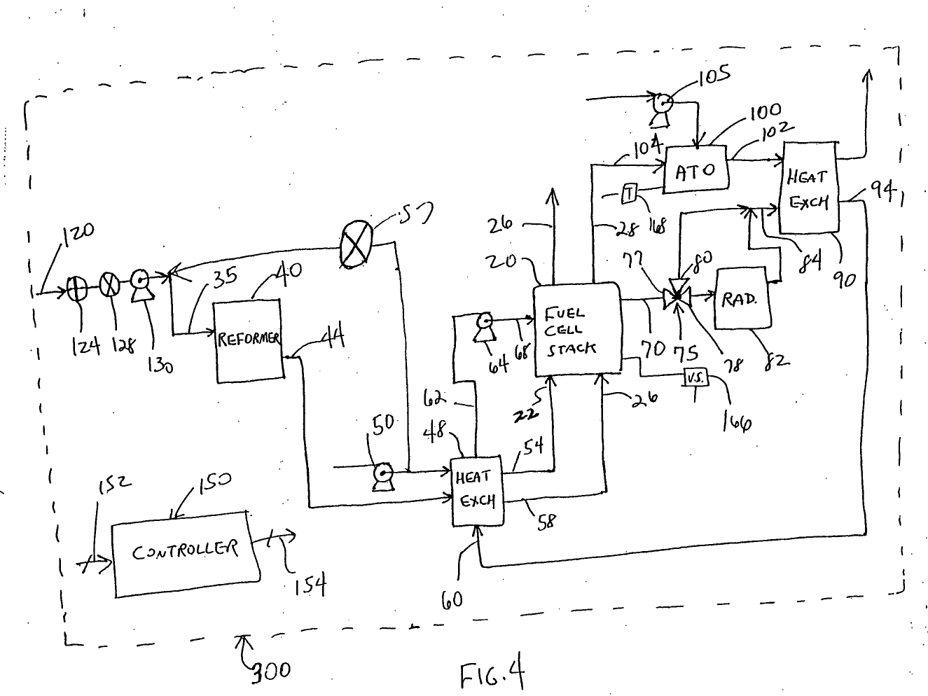

As a more specific example, FIG. 4 depicts a fuel cell system 300 in accordance with another embodiment of the invention. The fuel cell system 300 has a similar design to the fuel cell system 10 (see FIG. 1), with like reference numerals being used, with the following differences. In particular, the fuel cell system 300 does not recirculate the cathode exhaust (appearing at the cathode exhaust outlet 26) back to the inlet 35 of the reformer 40. Instead, the cathode exhaust may be furnished to, for example, a flare or oxidizer or may be vented directly to the surrounding environment. The controller 150 may open a valve 57 to flow oxidant from the blower 50 through the reformer 40, into the anode chamber of the fuel cell stack 20 and through the oxidizer 100. Therefore, many variations are possible and are within the scope of the appended claims.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method usable with a fuel cell system, comprising:
shutting off a fuel flow to an anode chamber of a fuel cell stack of the system; and
providing an oxidant flow to fuel passageways of the fuel cell system until fuel is significantly purged from the system.

2. The method of claim 1, further comprising:
providing a recirculation path to communicating an exhaust flow received from an outlet of the cathode chamber back to an inlet of the anode chamber, wherein the act of providing the oxidant flow comprises the oxidant flow to a cathode chamber of the fuel cell stack.

3. The method of claim 2, wherein the act of providing the recirculation path comprises:
communicating the exhaust flow to a fuel processor of the fuel cell system.

4. The method of claim 3, wherein the act of providing the recirculation path further comprises:
communicating an output flow from the fuel processor to the anode chamber of the fuel cell stack.

5. The method of claim 1, further comprising:
determining whether the fuel is significantly purged from the system based on a voltage of the fuel cell stack.

6. The method of claim 1, further comprising:
communicating an exhaust flow from the anode chamber to an oxidizer.

7. The method of claim 6, further comprising:
determining whether the fuel is significantly purged from the system based on a temperature of the oxidizer.

8. A fuel cell system comprising:
a fuel cell stack comprising an anode chamber and a cathode chamber; and
a control subsystem adapted to shut off a fuel flow to the anode chamber and provide an oxidant flow to purge fuel passageways of the fuel cell systems until fuel is significantly purged from the system.

9. The fuel cell system of claim 8, further comprising:
an oxidizer adapted to receive a flow from the anode chamber.

10. The fuel cell system of claim 9, wherein the control subsystem is adapted to shut off the fuel flow in response to fuel being significantly purged from the oxidizer.

11. The fuel cell system of claim 9, wherein the control subsystem is adapted to shut off the fuel flow in response to fuel being significantly purged from the anode chamber and from the oxidizer.

12. The fuel cell system of claim 9, wherein the control subsystem is adapted to shut off the fuel flow in response to a temperature of the oxidizer.

13. The fuel cell system of claim 8, wherein the control subsystem is adapted to shut off the fuel flow in response to a voltage of the fuel cell stack.

14. The fuel cell system of claim 8, wherein the control subsystem comprises:
a recirculation path adapted to communicate an exhaust flow received from an outlet of the anode chamber, and
the control subsystem is adapted to provide the oxidant flow to the cathode chamber.

15. The fuel cell system of claim 14, wherein the recirculation path comprises a fuel processor in communication with the anode chamber.

16. The fuel cell system of claim 15, wherein the control subsystem comprises:
a valve to control communication between a fuel source and the fuel processor, and
a controller adapted to control the valve to selectively shut off communication between the fuel source and the fuel processor.

17. A fuel cell system comprising:
a fuel cell stack comprising an anode chamber and a cathode chamber;
an oxidant source provide an oxidant source to the cathode chamber when the oxidant source is enabled;
a fuel processor to provide a reformate flow to the anode chamber;
a valve to control a hydrocarbon flow to an inlet of the fuel processor;
a flow path to communicate an exhaust flow from the cathode chamber to the inlet of the fuel processor; and
a controller to shut down the fuel cell system, the controller adapted to:
control the valve to shut off a fuel flow to the anode chamber; and
after the shutting off of the valve, continue to use algorithms which are used during operation of the fuel cell stack before the shut off of the valve to regulate operation of the fuel cell stack; and
after the shutting off of the valve, shutting down the fuel cell system in response to fuel being significantly purged from the system.

18. The fuel cell system of claim 17, wherein the controller is adapted to maintain the oxidant source enabled until a determination that the fuel is significantly purged from the system.

19. The fuel cell system of claim 17, wherein the controller is adapted to make the determination that the fuel is significantly purged from the system based at least on a voltage of the fuel cell stack.

20. The fuel cell system of claim 17, further comprising:
an oxidizer adapted to receive an exhaust flow from the anode chamber.

21. The fuel cell system of claim 20, wherein the controller is adapted to make the determination that the fuel is significantly purged from the system based at least on a temperature of the oxidizer.
